(19) United States
(12) Patent Application Publication
(10) Pub. No.: US 2024/0082788 A1
(43) Pub. Date: Mar. 14, 2024

(54) Method for Operational Control of a Water Treatment Unit and Water Treatment Unit for Implementing Such a Method

(71) Applicant: INOVAYA, Lyon (FR)

(72) Inventors: Khaled-Valentin Al Mezayen, Lyon (FR); Sylvain Masson, Villeurbanne (FR)

(21) Appl. No.: 18/274,386

(22) PCT Filed: Feb. 10, 2022
(86) PCT No.: PCT/EP2022/053196

§ 371 Date: Jul. 26, 2023

(30) Foreign Application Priority Data
Feb. 10, 2021 (FR) FR2101272

(51) Int. Cl. B01D 61/22; B01D 61/14; B01D 63/02; B01D 65/02; C02F 1/00; C02F 1/44

(52) U.S. Cl. CPC B01D 61/22; B01D 61/145; B01D 63/02; B01D 65/02; C02F 1/008; C02F 1/444; B01D 2321/04; B01D 2321/08; B01D 2321/40; C02F 2209/40; C02F 2303/16

(57) ABSTRACT

The method for controlling a water treatment unit in operation comprising at least the following steps of determining (1000) a normalized flow-rate value (D48) per unit of surface area and per unit of pressure of an ultrafiltration membrane (48); water treatment (1004) if a difference (Δ1) between the normalized flow value and a first reference value (D48₁) is less than or equal to a first threshold value (D1); regeneration (1010) of the ultrafiltration membrane (48) if the difference (Δ1) between the normalized flow-rate value and the first reference value (D48₁) is greater than the first threshold value (D1). The regeneration step (1010) comprises at least sub-steps consisting of backwashing (1011) the ultrafiltration membrane (48); interrupting (1012) and maintaining interrupted the circulation of water in the treatment unit (2); heating (1014) the water in contact with the ultrafiltration membrane (48) in an filtration system with ultrafiltration membrane (44, 58) during the interruption sub-step; and after the heating step, backwashing (1016) the ultrafiltration membrane (48).

The invention relates to a method for controlling a water treatment unit in operation comprising at least one filtration system with ultrafiltration membrane. The invention further relates to a water treatment unit for implementing such a method. Such a water treatment unit can be used for the clarification, disinfection and reduction of pollutants in the water, more particularly micropollutants, such as endocrine disruptors, pesticide derivatives, herbicides. Such a water treatment unit can more particularly be used for making surface water drinkable, as per the standards of a Regional Health Agency in France.

In the field of water treatment, it is known how to arrange different filters on the path of a flow of water to be treated, in order to improve the quality of the water. The different filters can include filters operating according to an essentially mechanical principle, which define water passage orifices, more particularly filters equipped with ultrafiltration membranes.

It is thus known from WO-A-2008/047393 how to integrate an activated carbon filter into a first filtration unit, which is arranged upstream of a second filtration unit which is preferentially an ultrafiltration unit. Such approach combines the advantages of absorption filtration and fine mechanical filtration, by ultrafiltration. In said known equipment, the ultrafiltration membrane(s) tend to become clogged, under the effect of clogging agents or of solid pollutants carried by the flowing water. Said known equipment is provided with a plurality of non-return valves which prevent circulation in the opposite direction, and hence backwashing of the filters.

On the other hand, it is known in certain installations how to backwash filters by circulating a cleaning water therethrough, in the opposite direction to the normal direction of circulation of the water, corresponding to the water treatment. Even if such backwashing operations are carried out with care, same do not completely remove the clogging agents and pollutants, so that the permeability of an ultrafiltration membrane gradually decreases relatively quickly, unless chemicals are used to thoroughly clean the membrane, which requires human manipulation by a skilled workforce and induces a risk of pollution of the treated water.

JP-A-2008 289 959 discloses a filtration system which can be cleaned with a succession of steps during which the operation of the system is briefly interrupted. Water heated in a tank outside a filter is used when cleaning a filter. The cleaning efficiency is not optimal.

Similar problems arise with the equipment known from DE-U-29823757.

Such drawbacks are the drawbacks that the invention can more particularly overcome, by proposing a new method for controlling a water treatment unit in operation, wherein it is possible to extend the life of an ultrafiltration membrane, by minimizing the use of cleaning chemicals.

To this end, the invention relates to a method for controlling a water treatment unit in operation comprising at least one filtration system with ultrafiltration membrane, said method comprising at least the following steps:
a) determination of a normalized flow-rate value per unit of surface area and per unit of pressure of the ultrafiltration membrane
b) water treatment with the treatment unit if a difference between the normalized flow detected during the step a) and a first reference value is less than or equal to a first threshold value;
c) regeneration of the ultrafiltration membrane if the difference between the normalized flow-rate detected during the step a) and the first reference value is greater than the first threshold value;
   Furthermore, the regeneration step includes at least one sub-step consisting of:
c1) backwashing the ultrafiltration membrane.
   According to the invention, the regeneration step further comprises at least sub-steps consisting of:
c2) interrupting and keep interrupted the water circulation in the treatment unit;
c3) heating the water in contact with the ultrafiltration membrane in the filtration system with ultrafiltration membrane during sub-step c2); and
c4) after step c3), backwashing the ultrafiltration membrane.

By means of the invention, the regeneration step induces a surprising effect of a substantial increase in the permeability of an ultrafiltration membrane, which prolongs the service life thereof, without the use of chemicals during the backwash during the steps c1) and c4). The heated water within the filtration system is in contact with the membrane and acts on the membrane for the duration of sub-step c2), which improves cleaning. The operation of the treatment unit is thereby facilitated and becomes easier and can be managed remotely since it is not necessary for an operator to come on site to inject one or a plurality of cleaning products.

According to advantageous but non-mandatory aspects of the invention, such a method can incorporate one or a plurality of the following features, taken individually or according to any technically permissible combination.
Sub-step c2) is carried out for a length of time comprised between 15 min and 6 hours, preferentially between 30 and 90 minutes.
Sub-step c3) is carried out until reaching a temperature of the water in contact with the ultrafiltration membrane comprised between 10° C. and 30° C., preferentially between 15° C. and 25° C., preferentially still on the order of 20° C.
The method is carried out automatically, without human intervention.
The method comprises the following step, alternative to step 4c): d) cold backwash of the ultrafiltration membrane.
The regeneration step c) and cold backwash step d) are implemented alternately depending on
a difference between the value of the normalized flow detected during the step a) and a second reference value, and/or
the periodicity of a situation where the difference between the normalized flow value detected during the step a) and the first reference value is greater than the first threshold value, and/or
the percentage of treated water used for one or a plurality of successive backwash steps, and/or
at predetermined instants, and/or
depending on the amount of water treated in the treatment unit.
The first reference value is adjusted after the regeneration step c) and, if appropriate, after cold backwash step d).
The value of the normalized flow-rate determined during the step a) is related to a reference temperature.

According to another aspect, the invention relates to a water treatment unit configured for implementing a method as mentioned hereinabove, the unit comprising at least one filtration system with ultrafiltration membrane. According to the invention, said unit also comprises at least one system for heating the water present in the filtration system with ultrafiltration membrane and a system for measuring a pressure drop of a water flow through said filtration system with ultrafiltration membrane.

According to an advantageous aspect of the invention, the heating system comprises heating resistors in contact with a body of the filtration system with ultrafiltration membrane, annealed copper wires being coupled to resistors or infrared heating systems.

The invention will be better understood and other advantages of the invention will appear more clearly in the light of the following description of an embodiment of a treatment unit and of an method for controlling said unit in operation, following the principle thereof, given only as an example and made with reference to the enclosed drawings, wherein:

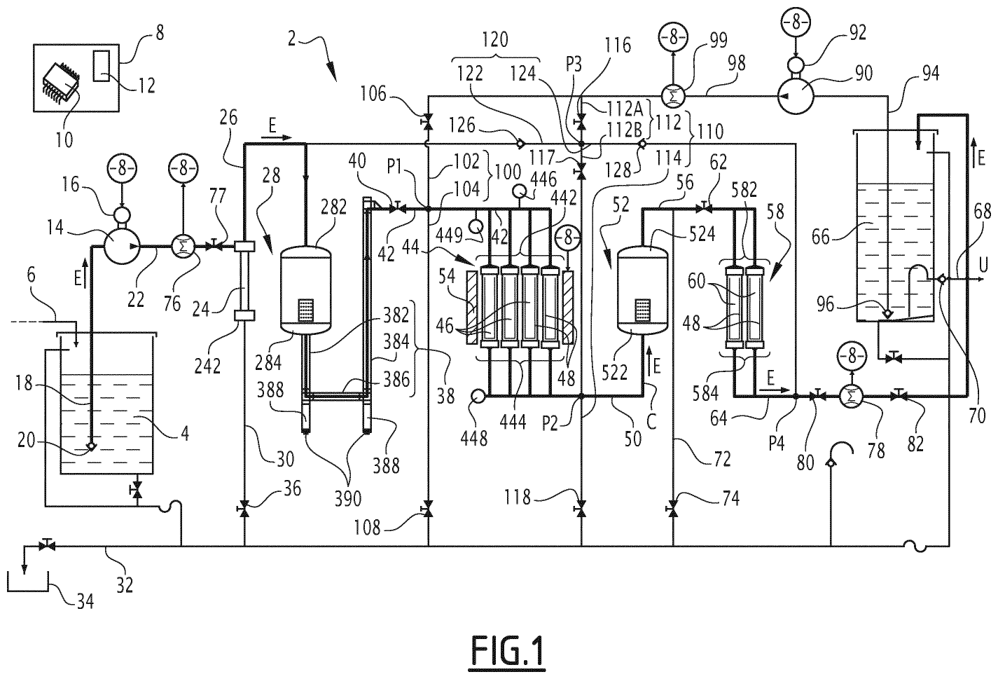

FIG. 1 is a block diagram of a water treatment unit according to the invention, in operation for the treatment of a quantity of water;

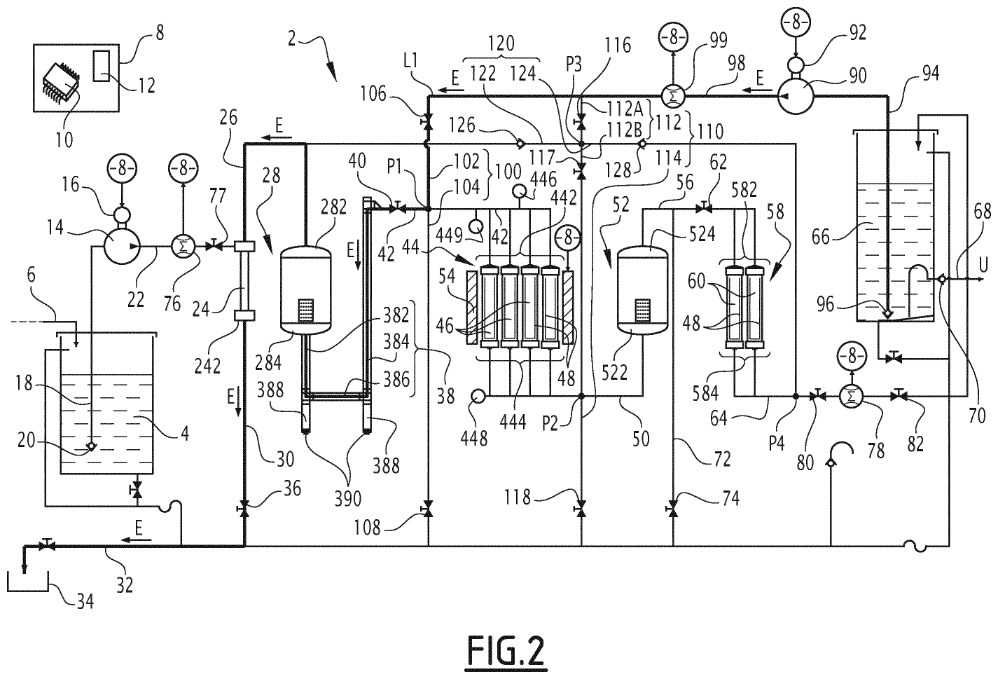

FIG. 2 is the same diagram as in FIG. 1, during a backwash of a first filtration system of the water treatment unit;

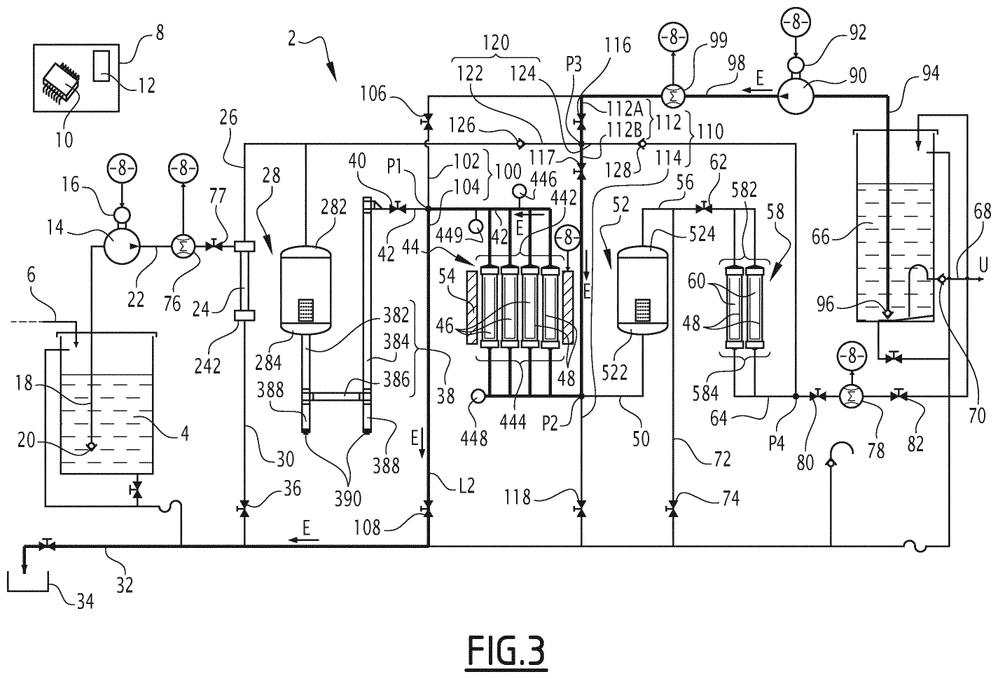

FIG. 3 is the same diagram as in FIG. 1, during a backwash of a second filtration system of the water treatment unit;

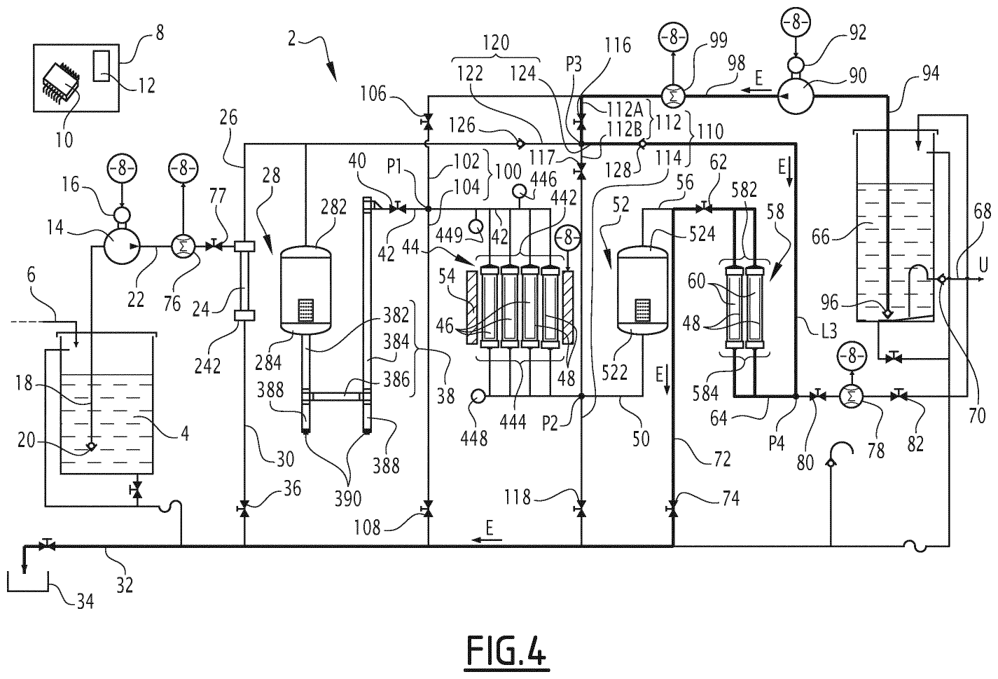

FIG. 4 is the same diagram as in FIG. 1, during a backwash of a third filtration system of the water treatment unit;

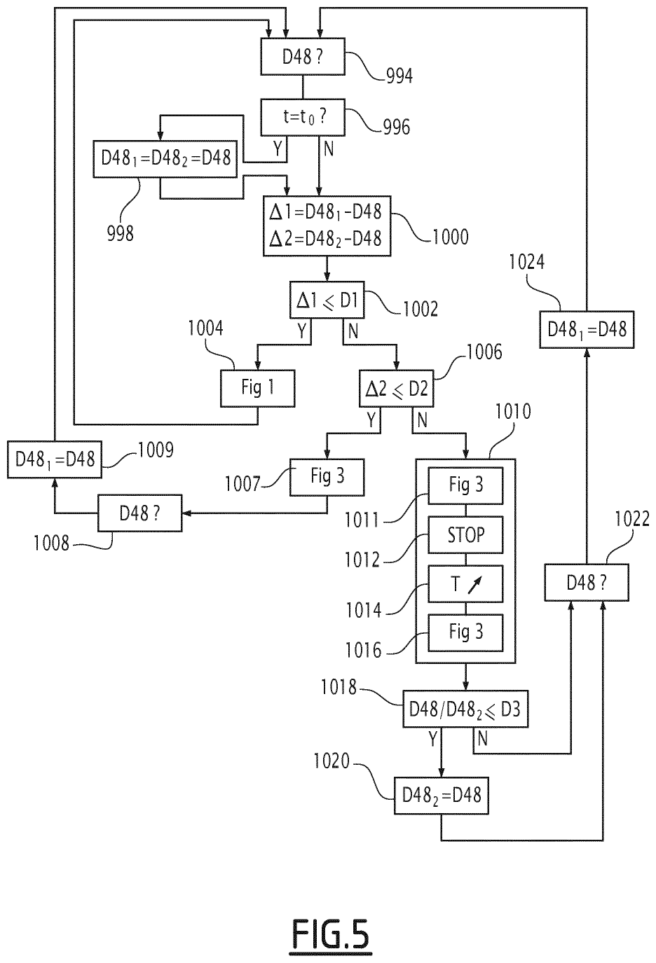

FIG. 5 is a block diagram illustrating a method for controlling in operation the water treatment unit shown in FIGS. 1 to 4; and

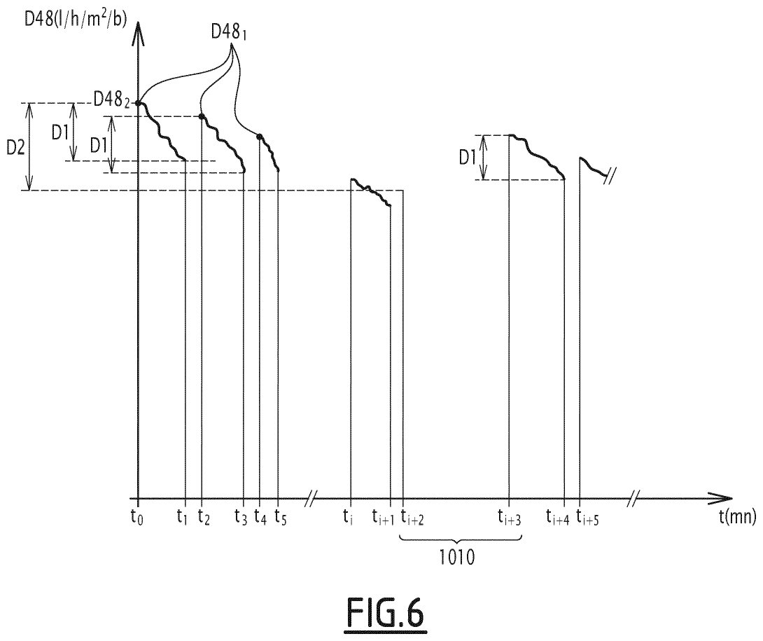

FIG. 6 is a representation of the change over time of a normalized flow-rate used in the method shown in FIG. 5.

The unit 2 shown in FIGS. 1 to 4 is used for pollutant clarification, disinfection and reduction in a quantity of water present in a tank 4 which belongs to the unit 2 and which is supplied with water to be treated via a pipe 6.

The treatment unit 2 further comprises a control board 8 which includes at least one microprocessor 10 and a memory 12 wherein is stored a program for controlling in operation the treatment unit 2. The control board 8 is connected to different members, such as meters or solenoid valves of the treatment unit 2 by links (not shown), which can be either wired or non-wired links. In the figures, dashed arrows having as origin or as destination the reference 8 surrounded by a circle show the transmission of information between certain members of the treatment unit 2, other than solenoid valves, and the control board 8. The control board also controls the various solenoid valves of the treatment unit, which are mentioned below, by means of wired or non-wired connections (not shown). The control board also receives the output signals from the pressure and temperature sensors mentioned hereinafter.

In FIGS. 1 to 4, the arrows E represent the direction of flow of the water in the pipes of the treatment unit 2.

In the present description, the inlet and outlet of a component of the treatment unit 2 are defined according to the normal direction of flow of water in said unit, as the part through which water enters or exits the component, when a flow of water is being treated within the unit.

The treatment unit 2 comprises a main pump 14 driven by an electric motor 16 controlled by the control board 8. An intake tubing 18 connected to the inlet of the main pump 14 plunges into the tank 4 and is equipped, at the upstream end, with a non-return valve 20.

The delivery outlet of the main pump 14 is connected by a pipe 22 to the inlet of a filtration system 24 with mechanical effect, e.g. a cyclone filter. The outlet of the mechanical effect filter 24 is connected by a pipe 26 to the inlet 282 of a filtration system 28 with activated mineral particles.

On the other hand, a drainpipe 30 connects a drain outlet 242 of the mechanical effect filter 24 to a collecting pipe 32 of water loaded with clogging agents and pollutants, which discharges into a tank 34 for collecting loaded water.

A solenoid valve 36, controlled by the control board 8, is arranged on the drainpipe 30.

The filtration system 28 contains an activated mineral particle filter formed by glass grains the size of which is comprised between 0.4 and 1 mm and the surface state of which is modified, in the sense that the glass grains can be qualified as “activated”. Such a filter is sold e.g. by the company Bayrol under the trademark AFM. The activation of the surface state of the glass grains induces an increase in the porosity thereof.

The fact that the filtering medium of the filtering system 28 is formed of grains means that the surface area of contact of the filtering medium with the water is relatively large, while imparting good compactness to the system. Furthermore, such type of filtering medium is compatible with a backwash, which would not necessarily be the case with a filtering medium having particles with a size less than 0.4 mm which could cause mineral particles to leak into the system.

The outlet 284 of the filtration system 28 is connected to a pipe 38 the diameter of which is greater than the diameter of the pipe 26 e.g. 1.5 times greater. Thereby, the cross-section of the water flow through the pipe 38 is widened with respect to the section of the pipes which are situated upstream and downstream. The pipe 38 is generally U-shaped, with two vertical branches 382 and 384 and a horizontal branch 386. The foot of each horizontal branch 382 and 384 is connected to a dead leg 388 equipped with a removable plug 390. Given the relatively large diameter thereof, the pipe 38 forms a zone for calming the flow of water at the outlet of the filtration system 28, which would allow solid particles which would be released into the water by the filter 28, to fall into the dead legs 190 where same can accumulate. In particular, activated mineral particles of the filtration system 28 are thereby prevented from abrading the membranes of the filters arranged downstream. It is also in this way possible to recover, by decanting, solid particles of clogging agents or of pollutant present in the water downstream of the filtration system 28.

During an operation of the treatment unit 2, and when all the pumps are stopped, it is possible to remove the removable plugs 390 for draining the dead legs 388 and recovering the solid particles which have accumulated therein.

When water circulates through the filtration system 28, a filter cake forms on the quantity of filter media consisting of the activated glass grains. The filter cake participates in the filtration exerted by the filtration system 28.

A solenoid valve 40 is arranged at the downstream end of the pipe 38. A pipe 42 connects the solenoid valve 40 to the inlet 442 of an ultrafiltration system 44 which comprises four ultrafiltration modules 46, each of the ultrafiltration modules comprising one or a plurality of ultrafiltration membranes 48, preferentially hollow fiber ultrafiltration membranes.

An ultrafiltration system, as defined by the present invention, is a filtration system designed for retaining particles the largest dimension of which is greater than or equal to 1 micrometer (μm). Herein, the ultrafiltration membranes 48 define pores for the passage of water, the largest average dimension of which is comprised between 0.01 μm and 1 μm, preferentially between 0.01 μm and 0.03 μm. The cut-off threshold of an ultrafiltration membrane is a particle size beyond which 90% of the particles are retained by the membrane. Experience shows that the cut-off threshold is generally on the order of 10% of the largest average pore size. Thereby, for pores with a larger average size equal to 1 μm, the cut-off threshold is about 0.1 μm.

The ultrafiltration modules 46, and thus the membranes 48 thereof, are preferentially identical. The ultrafiltration modules 46 extend in parallel between the inlet 442 and the outlet 444 of the ultrafiltration system 44. However, other arrangements of the ultrafiltration modules 46 are possible.

The ultrafiltration membranes 48 are e.g. made of poly(sulfone) (PSU), Kynar® type poly(vinylidene fluoride) (PVDF), of NEOPHIL® type modified PVDF or of a mixture of the first two materials mentioned.

A heating system 54 is arranged at the filtration system 44 and is used for raising the temperature of the water in contact with the ultrafiltration membranes 48. The heating system 54 is used, in particular, for preventing the water from freezing in the ultrafiltration system 44 when the operation of the treatment unit 2 stops.

The heating system comprises electrical resistors which are in thermal contact with a body of each module 46, which contains one or a plurality of ultrafiltration membranes 48 and are used for heating the water contained therein.

A pipe 50 connects the outlet 444 of the filtration system 44 to the inlet 522 of an activated carbon filtration system 52. The activated carbon is an adsorbent filter medium of the filtration system 52, apt in particular to remove micropollutants present in the water, whether organic or inorganic, such as certain dissolved metals. More particularly, an adsorbent media filter based on activated carbon is used for retaining micropollutants dissolved in the water to be treated, such as residues of pesticides, herbicides or drugs, or endocrine disruptors, and to make the water taste-neutral and odor-neutral.

On the other hand, a first pressure sensor 446 is arranged at the inlet of the filtration system 44 and is used for knowing the pressure of the water entering the filtration system, while a second first pressure sensor 448 is arranged at the outlet of the filtration system 44 and is used for knowing the pressure of the water coming out of the filtration system. The difference in the pressures measured by the sensors 446 and 448, respectively, is representative of the head loss in the filtration system 44.

A temperature sensor 449 is installed on the pipe 42 and is used for knowing the temperature of the water at the inlet of the filtration system 44.

A pipe 56 connects the outlet 524 of the activated carbon filtration system 52 to the inlet 582 of an ultrafiltration system 58 which comprises two ultrafiltration modules 60, which are preferentially identical to each other and to the ultrafiltration modules 46, and which each comprise an ultrafiltration membrane 48.

A solenoid valve 62 is arranged on the pipe 56, hence between the outlet 524 of the activated carbon filtration system 52 and the inlet 582 of the ultrafiltration system.

The outlet 584 of the ultrafiltration system 58 is connected by a pipe 64 to a tank 66 for collecting the treated water. The reservoir 66 is connected as such to a user U by a pipe 68 equipped with a non-return valve 70 and which plunges into the reservoir 66.

The tubing 18, the pipes 22, 26, 38, 42, 50. 56 and 64, as well as the filtration systems 24, 28, 44, 52 and 58 together define a flow circuit C for the water being treated in the unit 2.

A drainpipe 72 connects the pipe 56 upstream of the solenoid valve 62 to the collecting pipe 32. A solenoid valve 74 is placed on the pipe 72.

A first meter 76 is arranged on the pipe 22 between the main pump 14 and the mechanical effect filter 24.

A solenoid valve 77 is arranged on the pipe 22 between the meter 76 and the mechanical effect filter 24.

A second meter 78 is arranged in the pipe 64 between the outlet 584 of the ultrafiltration system 58 and the tank 66. A solenoid valve 80 is arranged upstream of the meter 78, on the pipe 64. A manual valve 82 is arranged downstream of the meter 78, on the pipe 94.

The comparison of the signals transmitted by the meters 76 and 78, respectively, to the control board 8, enables the microprocessor 10 to detect a leak, if any, in the flow circuit C.

On the other hand, the treatment unit 2 is equipped with a backwash subassembly which comprises a backwash pump 90 driven by an electric motor 92 controlled by the control board 8. An intake tubing 94 of the backwash pump 90 plunges into the tank 6 and is equipped, at the upstream end thereof, with a non-return valve 96.

The delivery outlet of the backwash pump 90 is connected by a pipe 98 to two branches 100 and 110 which extend in parallel between the pipe 98 and the collecting pipe 32. The pump 90 is thus a booster pump for feeding in ultrafiltered clean water, in other words water treated by the installation 2, of the pipe 98.

A meter 99 is installed on the pipe 98 and is used for notifying the control board 8 how much treated water is used to perform each backwash operation.

The branch 100 comprises a first section 102 which connects the pipe 98 to a point P1 of the pipe 42 situated between the solenoid valve 40 and the upstream side 442 of the filtration system 44. The second section 104 of the branch 100 connects the point P1 to the collecting pipe 32. Two solenoid valves 106 and 108 are arranged on the sections 102 and 104, respectively.

The branch 110 comprises a first section 112 which connects the pipe 98 to a point P2 of the flow circuit C situated on the pipe 50, between the outlet 444 of the ultrafiltration system 44 and the inlet 522 of the activated carbon filtration system 52. The section 112 is divided into a first arm 112A which connects the pipe 98 to a point P3 and a second arm 112B which connects the point P3 and the point P2. Three solenoid valves 116, 117 and 118 are arranged on the arms 112A and 112B and on the section 114, respectively.

The point P3 connects the section 112 to a pipe 120 which connects the pipe 26, upstream of the inlet 282 of the filtration system 28, to the pipe 64, downstream of the outlet 584 of the ultrafiltration system 58. The point P3 divides the pipe 120 into two sections 122 and 124, each equipped with a non-return valve 126 and 128 respectively, which lets the flow through when moving away from the point P3 and blocks the flow in the opposite direction.

The section 122 connects the pipe 26 to the point P3. The section 124 connects the point P3 to a point P4 of the flow circuit C located on the pipe 64, upstream of the solenoid valve 80.

The pipes 98, 100, 110 and 120 and the valves fitted thereto also belong to the backwash subassembly of the treatment unit 2.

In FIG. 1, the pipes of the circuit C for the flow of the water during treatment in the unit 2 are shown in thick lines, since it is the part of the treatment unit 2 wherein the water circulates, from the tank 4 to the tank 66.

During such circulation, the water is cleared of the particles and pollutants contained therein by passing successively through the filtration systems 24, 28, 44, 52 and 58.

The filtration system 24 is used for carrying out a relatively coarse filtration, which prevents clogging agents and pollutants of large size, typically greater than 150 μm, from flowing into the filtration system 28 which same could then rapidly clog.

The filtration system 28 is used, due to the mechanical effect of the activated mineral particles and of the cake present in the bed of particles, for clearing the flow of clogging agents and relatively fine pollutants, typically with a maximum dimension on the order of 4 μm.

The calming zone formed by the pipe 38 protects the ultrafiltration membranes 48 from any release of mineral particles from the filter 28 which could cause abrasion and a reduction of the service life of the ultrafiltration membranes 48.

The water then reaches the ultrafiltration system 44 where the ultrafiltration membranes 48 retain the plugging agents and pollutants of a size greater than the cut-off threshold of the membranes 48, i.e. between 0.01 μm and 0.1 μm.

The water which reaches the activated carbon filtration system 52 is thus cleared of a large part of the clogging agents and pollutants thereof, which prevents a rapid clogging of the activated carbon filter.

Thereby, the filtration systems 24 and 28 protect the ultrafiltration system 44 against rapid clogging and the filtration systems 24, 28 and 44 protect the filtration system 52 against rapid clogging.

In the normal configuration of water treatment in the flow circuit C, the second ultrafiltration system 58 has a safety function since same blocks, by means of the membranes 48 thereof, particles which could have passed in the upstream filtration systems, namely the filtration systems 24, 28, 44 and 52. The safety function is particularly important in the event of rupture of one of the ultrafiltration membranes 48 of the first ultrafiltration system 44.

The number of ultrafiltration modules 46 is higher than the number of ultrafiltration modules 60. Indeed, under normal conditions of use of the treatment unit 2, it is mainly the ultrafiltration system 44 which performs the ultrafiltration function. Thereby, even if the number of ultrafiltration modules 60 is smaller than the number of the ultrafiltration modules 46, the cumulative surface area of the ultrafiltration membranes 48 of the second ultrafiltration system 58 is sufficient for filtering the water coming out of the filtration system 52, because said water has already undergone an ultrafiltration operation within the first ultrafiltration system 44. In other words, the water downstream of the filtration systems 44 and 52 is less likely to clog the ultrafiltration membranes 48 of the second filtration system 58, than is the water at the outlet of the filtration system 28 likely to clog the ultrafiltration membranes 48 of the first ultrafiltration system 44. For the above reason, the cumulative surface area of the ultrafiltration membranes 48 of the second filtration system 58 can be smaller than the cumulative surface area of the ultrafiltration membranes 48 of the ultrafiltration system 44.

The different solenoid valves of the treatment unit 2 are controlled by the control board 8. In the configuration shown in FIG. 1, the solenoid valves 77, 40, 62 and 80 are controlled in the open position by the control board 8, while the other solenoid valves are controlled in the closed configuration. The non-return valves 126 and 128 prevent a short-circuit water flow, in parallel with the circuit C, between the points P1 and P3, and a water flow from the flow circuit C to branch 110.

As the treatment unit 2 progressively operates, the different filtration systems tend to become clogged.

For the above reason, the treatment unit 2 is configured for allowing backwash steps of some of the filtration systems thereof.

Backwashing of a filtration system can take place at predetermined times, e.g. every 1 hour of use of the unit 2, or taking into account the actual fouling of one or a plurality of the filtration systems, where the fouling can be determined for each filtration system by measuring the head loss therein, e.g. by means of pressure sensors.

During a backwash step, the operation of the main pump 14 is stopped and the backwash pump 90 is activated.

When it is necessary to backwash the filtration systems 24 and 28, the solenoid valves 106, 40 and 36 are controlled in the open position by the control board 8, while the other solenoid valves are controlled in the closed position.

In such case, the water drawn from the tank 66 by the recirculation pump 90 circulates in the tubing 94, in the pipe 98, in the section 102 of the branch 100, as far as the point P1, in the pipes 42 and 38, through the filtration system 28, in the opposite direction to normal operation, i.e. from the outlet 284 thereof to the inlet 282 thereof, in the pipe 26, through the filtration system 24, up to the drain outlet 242 thereof, and in the pipe 30, until reaching the collecting pipe 32.

Such backwash step is represented in FIG. 2 where the pipes wherein the water actually circulates form together a first backwash line L1 identified by thick lines.

Since the backwashing is carried out with treated water drawn from the tank 66, the risks of contamination of the filtration systems 24 and 28 are largely eliminated. The above also applies in the other backwash configurations mentioned hereinafter.

The duration of the backwash of the filtration systems 24 and 28 can be between 15 seconds (s) and 8 minutes (min), preferentially between 30 s and 2 min. In practice, a backwash of the filtration systems 24 and 28 can be provided if the head loss between the inlet 282 and the outlet 284 of the filtration system 28 is greater than a first threshold value V1, e.g. equal to 2 bar. The head loss is measured by pressure sensors (not shown) known per se.

When it is necessary to backwash the filtration system 44, the backwash pump 90 is activated and the solenoid valves 116, 117 and 108 are controlled in the open position by the control board 8, while the other solenoid valves are controlled in the closed position. In this way it is possible to circulate water coming from the tank 66 in the tubing 94, in the pipe 98, in the branch 112 of the pipe 110 as far as the point P2, in the pipe 50, through the filtration system 44 in the opposite direction, from the outlet 444 to the inlet 442 thereof, in the line 42 to point P1. Since the solenoid valve 40 is closed, the backwash water can then flow only in the section 104 of the pipe 100 to the collecting pipe 32, then to the tank 34.

Such backwashing step is represented in FIG. 3 where the pipes wherein the water actually circulates, together constituting a second backwash line L2 identified by thick lines.

The control board 8 automatically implements a method for controlling in operation the treatment unit 2 which considers a standardized flow-rate D48 assigned to the combined ultrafiltration membrane, consisting of all the ultrafiltration membranes 48 of the different ultrafiltration modules 46. Hereinafter, the different ultrafiltration membranes 48 are assimilated into the combined membrane, which is also called “combined ultrafiltration membrane 48” for the sake of simplification.

The method is implemented by the microprocessor 10, by executing a software program stored in the memory 12.

The standardized flow-rate D48 is expressed per unit of surface area of the combined ultrafiltration membrane 48, in the present case per m², and per unit of pressure of the ultrafiltration membrane, in the present case in bars, denoted hereinafter by “b”. The normalized flow-rate is corrected by a temperature coefficient calculated from the temperature recorded at the inlet of the filtration system 44 by the sensor 449 and from a mathematical function given by the membrane manufacturer. Since a flow-rate is conventionally expressed in liters/hour, the standardized flow-rate D48 can thus be expressed in l/h/m²/b.

The normalized flow-rate D48 is representative of the permeability of the combined ultrafiltration membrane 48 insofar as the more permeable the combined ultrafiltration membrane 48, the higher the normalized flow-rate. The flow-rate D48 is thus a datum characterizing the fouling of the membranes, independently of the viscosity of the water, the membrane surface and the pressure difference across of the membranes.

Within the treatment unit 2, the standardized flow-rate D48 is measured by means of the meters 76 and/or 78 which are used for determining the water flow-rate, in I/h, in the flow circuit C and, by the pressure sensors 446 and 448 which are used for knowing the pressure difference on both sides of the combined ultrafiltration membrane 48.

The surface area of the combined ultrafiltration membrane 48 is known from the technical features of the different ultrafiltration modules 46. Such datum is generally communicated by the manufacturer of the ultrafiltration modules and can be stored in the memory 12, as an operating parameter of the treatment unit 2.

Thereby, the control board 8 is apt to calculate, at each instant t and in a first step 994 of the method of the invention, the standardized flow-rate D48 of the combined ultrafiltration membrane 48.

The first step 994 is implemented periodically, starting from a time to of starting the unit 2, with a periodicity comprised between 2 and 90 seconds, preferentially equal to 15 seconds.

In a second step 996, it is verified whether the time t of implementation of step 994 is the time to. If such is the case, an initialization step 998 is implemented, during which a first reference value D48₁ and a second reference value D48₂ are made equal to the value D48 of the normalized flow-rate determined during the step 994.

After step 998 if the instant t is equal to to, or directly after the step 996 if the instant t is different from to, a step 1000 is implemented, wherein two differences are calculated, namely,
a first deviation value Δ1, equal to the difference between the first reference value D48₁ and the value calculated during the step 994; and
a second deviation value Δ2, equal to the difference between the second reference value D48₂ and the value calculated during the step 994.

We have the following relationships: Δ1=D48₁−D48 and Δ2=D48₂−D48.

In a subsequent step 1002 of the method, the first difference or difference value Δ1 determined during the step 1000 is compared with a threshold value D1 set in advance, e.g. equal to 1 l/h/m²/b.

If, during the step 1002, it is determined that the first difference value Δ1 is less than or equal to the threshold value D1, it is interpreted by the microprocessor 10 as the fact that the normalized flow-rate D48 has decreased slightly with respect to the reference value D48₁ thereof. In such case, the combined ultrafiltration membrane 48 is considered as not clogged and not fouled and the plant can operate normally for treating the water, in the configuration shown in FIG. 1. The above takes place during a step 1004 of the method of the invention.

The method then returns to the step 994.

Otherwise, i.e. if the first difference value Δ1 is strictly greater than the threshold value D1, it is interpreted by the control board 8 as the fact that the fouling or the clogging of the ultrafiltration membranes begins to be significant. In such case, a backwash step 1007 or a regeneration step 1010 for the ultrafiltration membrane 48 is provided.

In the representation shown in FIG. 6, it is considered that the treatment unit 2 starts at the instant t₀. During the operation of the treatment unit 2, the combined ultrafiltration membrane 48 progressively fouls, so that the value of the standardized flow-rate D48 decreases progressively until the first difference value Δ1 reaches the threshold value D1 at a time t₁, which is detected during the step 1002.

In such case, a comparison step 1006 is implemented, during which the second difference value Δ2 determined during the step 1000 is compared with a second threshold value D2 set in advance, e.g. equal to 3.5 l/h/m²/b.

If, during the step 1006, it is determined that the second difference value Δ2 is less than or equal to the threshold value D2, it is interpreted by the control board 8 as the fact that the normalized flow-rate D48 has decreased relatively little with respect to the reference value D48₂ thereof at the instant t₀. In such case, the backwash step 1007 is initiated, at the instant t₁ and up to an instant t₂, step during which ultrafiltered water circulates in the backwash line L2, as explained above and represented in FIG. 3.

The backwash step takes place in cold conditions, in the sense that the heating system 54 is not activated at the instant t₁, nor in the period following said instant, at least until the instant t₂.

Such cold backwash step continues until the instant t₂ when the booster pump 90 is stopped, and the main pump 14 is again put into service, which makes it possible to determine again the value of the standardized flow-rate D48 during the step 1008. Such new value of the normalized flow-rate D48 is normally greater than the value determined at the instant t₁, and usually slightly less than the reference value D48₁, as can be seen in FIG. 6.

After the step 1008, the reference value D48₁ is adjusted, during a step 1009, to the value of the normalized flow-rate D48 determined during the step 1008. In other words, the first reference value D48₁ is thus adjusted to the value determined at the end of the cold backwash step 1007.

After carrying out the step 1009, the method returns to the step 994.

From the instant t₂ on, the installation operates again for water treatment, in the configuration shown in FIG. 1, and the normalized flow-rate is again determined during the step 994. Steps 1000 and 1002 are implemented again, without implementing the step 998. Step 1004 is implemented until an instant t₃ when the value of the normalized flow-rate D48 is such that the first difference value Δ1 exceeds the threshold value D1.

At the instant t₃, a new comparison step 1006 is implemented and, if the result of the comparison is that the second difference value Δ2 determined during the step 1000 is less than the threshold value D2, a new cold backwash step 1007 is then implemented.

Step 1007 extends until an instant to when the installation returns to the water treatment configuration, with the main pump 14 operating and the booster pump 90 stopped. Steps 1008 and 1009 are implemented again, before the steps 994, 996, 1000 and 1002.

The operation continues until a new instant is at which the value of the first difference value Δ1 becomes strictly greater than the threshold value D1, at which instant the steps 1006 et seq. are implemented again.

The succession of steps 1007 to 1009 thus make possible, a backwash of the filtration system and the updating of the first reference value D48₁ which hence corresponds, during a normal operation of the unit 2 after a cold backwash, to the value of the normalized flow-rate D48 at the beginning of normal operation. Thereby, as shown in FIG. 6, the variation of the normalized flow-rate D48 over time is compared with the threshold value D1 for each period of normal operation, taking into account the starting value of the flow-rate over said period.

The steps 1007 to 1009 have no influence on the second reference value D48₂. The operation described hereinabove continues as long as the comparison step 1006 does not detect that the value of the normalized flow-rate D48 differs by more than the threshold value D2 of the second reference value D48₂. If, during the step 1006, it is determined that the second difference value Δ2 is strictly greater than the threshold value D2, it is interpreted by the control board 8 as the fact that the normalized flow-rate D48 has decreased significantly with respect to the reference value D48₂ thereof at time to, to the point that a step 1010 of regeneration of the membrane has to be carried out.

The above is represented in FIG. 6 at a time tᵢ₊₂ of resumption of operation of the treatment unit 2, after a cold backwash occurring at the end of a normal operation period between the instants t₁ and tᵢ₊₁.

The regeneration step 1010 which then begins at the instant comprises a first sub-step 1011 of cold backwash of the combined ultrafiltration membrane 48, which is used for discharging some of the clogging agents and of the pollutants, as explained hereinabove with reference to FIG. 3 and as done during the step 1007.

The regeneration step 1010 comprises a second sub-step 1012 wherein the circulation of water in the treatment unit 2 is stopped and kept stopped, more particularly the two pumps 14 and 90 are stopped. Such interruption of the circulation of water in the treatment unit 2 has the effect that the water present in the ultrafiltration system 44 stagnates in said system, around the combined ultrafiltration membrane 48.

In a third sub-step 1014 of the regeneration step 1010, the water in contact with the ultrafiltration membrane 48 is heated by the heating system 54, which is activated by the control board 8. The heating sub-step takes place during the entire period when the water circulation is interrupted, i.e. during the entire sub-step 1012. In other words, sub-steps 1012 and 1014 are concurrent.

During the sub-step 1014, the temperature T of the stagnant water in contact with the ultrafiltration membrane 48 increases to a value which can be set between 10° C. and 30° C., preferentially between 15° C. and 25° C., preferentially still on the order of 20° C.

The temperature T can be detected by means of a temperature sensor integrated into at least one of the ultrafiltration modules 46, which can be of any known type and which is not shown in the figures, for the sake of simplification

In practice, the sub-step 1012 is carried out for a period, the length of time of which is comprised between 15 minutes and six hours, preferentially between 30 and 90 minutes.

Such period of interruption of the circulation of water during the sub-step 1012 corresponds to the length of time of the sub-step 1014 of heating the water and is used for obtaining a significant rise in temperature of the water in contact with the ultrafiltration membrane 48. The value of 30 minutes is, in practice, a minimum for obtaining a significant rise in the temperature T of the mass of water which stagnates in the filtration system 44. The value of 6 h is, in practice, a maximum because tests have shown that a longer period of interruption of circulation and of heating does not significantly improve the performance of the backwash, or even reduces the performance thereof for longer periods, whereas same reduces the efficiency of the treatment unit 2.

The regeneration step 1010 comprises a fourth sub-step 1016, subsequent to the sub-step 1012 and 1014 and consisting in backwashing the filtration system, as explained hereinabove with reference to FIG. 3. The sub-step 1016 begins with the water which has been heated during the sub-step 1014.

Surprisingly, the backwash carried out during the sub-step 1016 is much more efficient than the cold backwash carried out during the step 1007 in that the value of the normalized flow-rate D48, determined when the treatment unit 2 is restarted at an instant tᵢ₊₃ corresponding to the end of the step 1010, is significantly greater than the normalized flow-rate value determined during the last step 994, at the instant tᵢ₊₂ before the start of the regeneration step 1010 and greater than the first reference value D48₁ updated during the last step 1009. The permeability of the combined ultrafiltration membrane is thus substantially increased during the regeneration step 1010.

Tests have made it possible to observe, in an example where the threshold value D 2 is close to 3.5 l/h/m²/b, an increase in the standardized flow-rate D48 on the order of 4.2 l/h/m²/b at the end of a regeneration step 1010, compared with the value thereof before said step. Thereby, the value of the normalized flow-rate D48 becomes greater by 0.7 l/h/m²/b than the value D48₂.

Thereby, the regeneration step 1010 can be used for increasing in steps, the standardized flow-rate D48 to a value on the order of +7 l/h/m²/b in ten production/backwash and regeneration cycles, rather than to observe a loss of permeability generally encountered during production/backwash cycles without regeneration.

During the service life of the treatment unit 2, even if the regeneration steps 1010 are successively used, the combined ultrafiltration membrane 48 can become progressively clogged, even if less rapidly than without regeneration.

The above can be measured by determining, during a step 1018 subsequent to step 1010, the variation of the value of the normalized flow-rate D48, determined during the last step 994 before the regeneration step, with respect to the second reference value D48₂. Such variation can be calculated in the form of the ratio D48/D48₂. The ratio is compared with a threshold value D3, herein chosen equal to 1.

If the ratio D48/D48₂ is strictly greater than the threshold value D3, then the microprocessor 10 considers that the normalized flow-rate has increased and that the method can continue to be implemented with the same value of D48₂ as before.

Otherwise, i.e. if the ratio D48/D48₂ is less than or equal to the threshold value D3, then it is considered that the normalized flow-rate has decreased with respect to the instant to, or to the last instant when the value of D48₂ was set, and, during a step 1020, the value D48₂ is recalibrated on the last value of the normalized flow-rate determined during the step 994. The above is equivalent to shifting the origin point of the comparison made during the next steps 1006.

After the step 1018, and possibly after the step 1020, two steps 1022 and 1024 are implemented, which are the same as steps 1008 and 1009, respectively, and are used for adjusting the first reference value D48₁ to the value determined after the regeneration step 1010.

The numerical values given above for the threshold values D1, D2 and D3 are not limiting. For example, the threshold value D1 can be between 0.1 and 5 l/h/m²/b, preferentially between 0.5 and 2 l/h/m²/b, the threshold value D2 can be between 1 and 10 l/h/m²/b, preferentially between 2 and 41/h/m²/b, and the threshold value D3 can be between 0.95 and 1, preferentially equal to 1. In all cases, the threshold value D1 is strictly less than the threshold value D2.

In a variant, step 1006, which makes it possible to choose between the implementation of the step 1007 of cold backwashing or the implementation of the regeneration step 1010, can be based on a criterion other than the comparison of the second difference value Δ2 with the threshold value D2.

More particularly, by using the output signals of the meters 76, 78 and 99, it can be considered that the regeneration step 1010 is implemented if the water consumed during one or a plurality of successive cold backwash steps 1007 represents a percentage greater than or equal to a threshold value, e.g. 30%, of the water treated by the unit 2 over a period of time. Otherwise, the cold backwash step 1007 is implemented.

According to another approach, the cold backwash 1007 and the regeneration 1010 steps can be distributed over time at fixed intervals. For example, a backwash step 1008 can be provided for every 15 minutes and a regeneration step 1010 can be provided for every 4 hours. In such case, it is not necessary to implement a step comparable to step 1006 and the internal clock of the control board 8 makes it possible to manage such aspect.

According to another approach, the distribution between the cold backwash 1007 and the regeneration 1010 steps can be carried out depending on the quantity of water treated in the installation. For example, a cold backwash step 1007 can be implemented after the treatment of 200 liters of water and a regeneration step 1010 can be implemented after the treatment of 2000 liters of water. In such case, too, it is not necessary to implement a step comparable to step 1006.

According to yet another approach, the repartition between the cold backwash 1007 and the regeneration 1010 steps can be carried out taking into account the frequency of implementation of the cold backwash 1007 steps. For example, it can be considered that if the normal operating time, in the configuration of FIG. 1, between two interruptions for backwashing, is less than 10 minutes, then a regeneration step has to be implemented.

The regeneration step 1010 can also be implemented as a priority when the filtration system does not deliver drinking water, e.g. at night, in particular if the system is powered by photovoltaic panels.

The above-mentioned approaches for determining how steps 1007 and 1010 are implemented can be combined with each other.

According to an optional aspect of the invention, applicable to all modes of repartition between the steps 1007 and 1010, the standardized flow-rate D48 can be related to a reference temperature, e.g. to the temperature of 20° C. In other words, the normalized flow-rate D48 is then corrected according to the difference between the temperature detected by the sensor 449 and the reference value. Such correction, which takes into account the properties of the combined ultrafiltration membrane 48, is carried out according to the indications of the manufacturer of the membrane.

Step 1010 prolongs the service life of the combined ultrafiltration membrane 48 by increasing the permeability thereof at the end of the regeneration steps 1010 without injecting chemical products for cleaning the ultrafiltration membrane, into the treatment unit 2.

One hypothesis would be that heating the water in contact with the ultrafiltration membrane 48, during the sub-step 1014, would bring the combined ultrafiltration membrane 48 and the clogging agents and pollutants present in the pores thereof and on the surface thereof to an optimal temperature, where the latter would form bonds therebetween, which would facilitate the separation of the clogging agents and of the pollutants with respect to the combined ultrafiltration membrane 48, during the backwash sub-step 116.

The above is potentially the reason why backwashing during the step 1016 is more efficient than backwashing without temperature variation during the step 1007, to the point that the value of the normalized flow-rate D48 would be higher at the end of the regeneration step 1010, compared to the same value at the end of the cold backwash step 1007.

The method of the invention has the advantage of being implemented automatically by the control board 8, without human intervention. More particularly, the method does not require the injection of cleaning products into the pipes of the treatment unit 2, which obviates the need for an operator to go, at regular intervals, to the place where the treatment unit 2 is installed.

The combination of the cold backwash 1007 and the regeneration 1010 steps is very advantageous, since same allows the cold backwash 1007 steps to quickly clean the ultrafiltration membrane 48 as long as this remains effective, whereas the regeneration step 1010 is used for a thorough cleaning, even if it takes longer.

According to a variant of the method of the invention, the sub-step 1014 can extend only over a part of the period of interruption of the sub-step 1012.

The cold backwash step 1007 is however optional and it is possible to envisage a method wherein the regeneration step 1010 is systematically implemented as soon as the value of the standardized flow-rate D48 becomes strictly lower than the first threshold value, different from the first reference value D48₁ by a difference strictly greater than the threshold value D1.

When it is necessary to backwash the filtration system 58, the backwash pump 90 is activated and the solenoid valves 116, 62 and 74 are switched to the open position by the control board 8, while the other solenoid valves are maintained in the closed position.

In this way it is possible to circulate the water taken from the tank 66 in the tubing 94, in the pipe 98, in the arm 112A as far as the point P3, in the branch 124, from the point P3 to point P4, in the pipe 64, in the filtration system 58, in the opposite direction, from the outlet 584 thereof to the inlet 582 thereof, in the pipes 62 and 72, as far as the collecting pipe 32. Downstream of the solenoid valve 62 in relation to the direction of flow of the water in said configuration, the backwash water does not backflow through the pipe 56 towards the outlet 524 of the filtration system 52, because the valves 40, 106, 108 are closed, 117 and 118 preventing a flow towards the outlet 524.

The backwash step is represented in FIG. 4 where the pipes wherein the water actually circulates, together constitute a third backwash line L3 identified by thick lines.

The backwash cycles of the filtration systems 44 and 58 can be carried out in an either coordinated or uncoordinated way, depending on the degree of fouling detected in the ultrafiltration membranes 48, the detection being possible by measuring a head loss or a standardized water flow per unit of time, per unit of surface area, per unit of pressure and at a given temperature. In a variant, the backwashing of the filtration systems 44 and 58 is carried out periodically independently of the head loss or of the standardized flow-rate.

The number of solenoid valves needed for operating the treatment unit 2 in the normal configuration where the water circulates in the circuit C or during the backwash steps, is relatively small. In the example, the treatment unit 2 comprises eleven solenoid valves.

The mechanical effect filtration system 24 serves as a prefilter for the series of four filtration systems 28, 44, 52 and 58. Depending on the quality of the water taken from the tank 4, the filtration system 24 can be omitted. Same is hence optional.

In a variant, the ultrafiltration system 44 or the ultrafiltration system 58 comprises only one ultrafiltration membrane. In such case, the cumulative surface area of one or other of the systems is equal to the surface area of the ultrafiltration membrane thereof.

In a variant, the numbers of ultrafiltration modules of the ultrafiltration systems 44 and 58 are different from 4 and 2 respectively. Same can be 2 and 1, 3 and 1, 5 and 3, 6 and 4, etc. depending on the unit surface area of each ultrafiltration membrane 48 and of the flow-rate of water to be treated in the unit 2.

According to another variant, a heating system of the type of the heating system 54 can be associated with the fourth filtration system 58. In such case, the method of the invention can also or alternatively be implemented with regard to the combined ultrafiltration membrane 48 of the second ultrafiltration system 58.

The heating system(s) 54 and/or the equivalent are not necessarily of the electrical resistance type and can, in a variant, consist of annealed copper wire (without oxygen) coupled to resistors or to infrared heating systems made of electrified carbon fiber (heated cloth strips).

According to yet another variant, the activated carbon filter system 52 can be replaced by another filtration system with an adsorbent filtering medium, e.g. zeolite in the form of grains which adsorbs compounds such as uranium.

According to another variant, the filtering medium can consist of metal granules covered with a layer of metal oxide. The granules can be iron granules covered with a layer of manganese oxide. A filter with filter media based on granules treated with manganese dioxide e.g. are used for retaining pollutants dissolved in the water to be treated, such as iron, manganese, arsenic, cadmium, hydrogen sulfide, and for making the water taste-neutral and odor-neutral.

According to yet another variant, the treatment unit 2 can include one or a plurality of additional filtration systems, arranged downstream of the filtration system with filtering media 52, such as an iron oxide filter or an ion exchange resin filter. Preferentially, such additional filtration system(s) are arranged, along the flow circuit C, between the filtration system with filtering media 52, i.e. with activated carbon in the example, and the second ultrafiltration system 58.

An ion exchange resin reduces e.g. ammoniacal nitrogen in water. The ion exchange resin can be of the anionic or cationic, in gel form or in macroporous form.

According to a particular application, if the water to be treated is brackish, or if it is seawater, the treatment unit 2 can be associated with a reverse osmosis or an electrodialysis or even a nano-filtration unit which is installed downstream of the unit 2. A nano-filtration unit is provided for retaining compounds or ions the largest dimension of which is on the order of an angstrom (A). A nano-filtration unit comprises one or a plurality of membranes with pores with a size generally comprised between 1 and 7 nm.

The treatment unit 2 can be used for clarification, disinfection and removal of micropollutants from surface water. The clarification is carried out by means of the filtration systems 28 and 44, the disinfection is carried out by means of the filtration systems 44 and 58 and the reduction of the micropollutants is carried out by means of the filtration media system 52. The treatment unit 2 can be used for making water drinkable, for the preparation thereof for use in an industrial method or for the pre-desalination thereof.

The aforementioned contemplated embodiments and variants can be combined for generating new embodiments of the invention.

1-10. (canceled)

11. A method for controlling a water treatment unit in operation comprising at least one filtration system with an ultrafiltration membrane, said method comprising the following steps:
a) determination of a normalized flow-rate value per unit of surface area and per unit of pressure of the ultrafiltration membrane;
b) water treatment with the treatment unit if a difference between the value of the normalized flow detected during the step a) and a first reference value is less than or equal to a first threshold value; and
c) regeneration of the ultrafiltration membrane, if the difference between the normalized flow-rate detected during the step a) and the first reference value is greater than the first threshold value, wherein the regeneration step comprises the following sub-steps:
c1) backwashing the ultrafiltration membrane;
c2) interrupting and keeping interrupted, the circulation of water in the treatment unit;
c3) heating the water in contact with the ultrafiltration membrane in the filtration system with ultrafiltration membrane during sub-step c2); and
c4) after step c3), backwashing the ultrafiltration membrane; or
d) as an alternative to step c), cold backwash of the ultrafiltration membrane

12. The method according to claim 11, wherein the sub-step c2) is carried out for a period of between 15 min and 6 hours.

13. The method according to claim 11, wherein the sub-step c2) is carried out for a period of between 30 and 90 min.

14. The method according to claim 11, wherein the sub-step c3) is carried out until reaching a temperature of the water in contact with the ultrafiltration membrane of between 10° C. and 30° C.

15. The method according to claim 11, wherein the sub-step c3) is carried out until reaching a temperature of the water in contact with the ultrafiltration membrane of between 15° C. and 25° C.

16. The method according to claim 11, wherein the sub-step c3) is carried out until reaching a temperature of the water in contact with the ultrafiltration membrane of about 20° C.

17. The method according to claim 11, wherein the method is carried out automatically without human intervention.

18. The method according to claim 11, wherein the regeneration step c) and the cold backwash step d) are carried out alternately depending on the following:
a difference between the value of the normalized flow-rate detected during the step a) and a second reference value;
the periodicity of a situation where the difference between the normalized flow-rate value detected during the step a) and the first reference value is greater than the first threshold value;
the percentage of treated water used for one or a plurality of successive backwash steps;
at predetermined instants; and/or
depending on the amount of water treated in the treatment unit.

19. The method according to claim 11, wherein the first reference value is adjusted after the regeneration step c) or after the cold backwash step d).

20. The method according to claim 11, wherein the value of the normalized flow-rate determined during the step a) is related to a reference temperature.

21. A water treatment unit configured for carrying out a method according to claim 1, wherein the water treatment unit comprises:
at least one filtration system with an ultrafiltration membrane;
at least one system for heating the water present in the filtration system with ultrafiltration membrane; and
a system for measuring a head loss of a water flow through the filtration system with ultrafiltration membrane.

22. The water treatment unit according to claim 18, wherein the heating system comprises heating resistors in contact with a body of the filtration system with ultrafiltration membrane, annealed copper wires coupled to resistors or infrared heating systems.
